(19) United States
(12) Patent Application Publication
(10) Pub. No.: US 2018/0078799 A1
(43) Pub. Date: Mar. 22, 2018

(54) ROPING HARNESS

(71) Applicant: ZEDEL, Crolles (FR)

(72) Inventor: Loïc BLONDEAU, La Tronche (FR)

(73) Assignee: ZEDEL, Crolles (FR)

(21) Appl. No.: 15/707,183

(22) Filed: Sep. 18, 2017

(30) Foreign Application Priority Data
Sep. 16, 2016 (FR) 1658711

(51) Int. Cl. A62B 35/00

(52) U.S. Cl. CPC A62B 35/0031; A63B 69/0048; A62B 35/0012

(57) ABSTRACT

A belt of a roping harness having a flexible knit support strip designed to support the dorsal part of a user, an adjustment device of the circumference of the belt having first and second ends fixed to the support strip in first and second positions, and at least three resistance threads each sewn onto the adjustment device in specific third and fourth positions. At least one of the resistance threads presents a larger length than the distance separating its third and fourth positions along the support strip. The belt includes guidelines formed by a knit fabric which secure the resistance threads with the support strip in separated manner from one another in a direction orthogonal to the longitudinal axis of the support strip. The roping harness comprises a pair of leg loops having similar features.

### FIELD OF THE INVENTION

The invention relates to a belt of a roping harness, to a pair of leg loops of a roping harness and to a roping harness comprising such a belt and/or pair of leg loops.

### STATE OF THE ART

In the field of rock climbing, mountain climbing, ski-mountaineering, or for working at height, roping harnesses enable the safety of persons to be ensured.

In conventional manner, a roping harness comprises a belt and a pair of leg loops. Depending on the type of use, the belt and leg loops can be more or less thick in order to ensure user comfort. For example, a harness designed for work at height has to be particularly comfortable to be able to be used for long periods. In rock climbing, the harness also has to be comfortable so as not to injure the lead climber if he falls when climbing on a route.

In the field of mountain climbing and ski-mountaineering, the harness is mainly designed for roping of a party. The thicknesses of the belt and of the leg loops can be smaller as the latter are rarely placed under tension. This results in a gain in weight and compactness appreciated by climbers, but to the detriment of their comfort.

In order to guarantee good conditions of use whatever the discipline practiced, it is important to make a trade-off between user comfort, the weight of the roping harness and its compactness. In this way, the harness is versatile and the user does not need several items of equipment.

It is also advantageous to provide a manufacturing method which is easy to implement.

### OBJECT OF THE INVENTION

One object of the invention consists in providing a belt for a roping harness that is easier to implement while at the same time ensuring a good user comfort.

The belt of the roping harness comprises:
a support strip designed to support the dorsal part of the user,
an adjustment device of the circumference of the belt having first and second ends fixed to the support strip in first and second positions,
at least three resistance threads each sewn onto the adjustment device in specific third and fourth positions,
at least one of the resistance threads presenting a longer length than the distance separating its third and fourth positions along the support strip.

The belt is remarkable in that the support strip is knit in such a way as to define:
distinct first and second blankets fixed to one another,
at least a first area where the first blanket is mechanically dissociated from the second blanket and
a plurality of second areas where the first blanket is fixed to the second blanket, the first and second blankets defining guide lines configured to secure the at least three resistance threads with the support strip and to prevent movement of the resistance threads in an orthogonal direction to the longitudinal axis of the support strip, the at least three resistance threads being arranged between the first blanket and the second blanket.

In one development, a resistance thread is associated with a group of guide lines, the guide lines being formed by a second area where the first blanket is inseparable from the second blanket, two guide lines being separated by a first area along the longitudinal axis.

In advantageous manner, the resistance threads are arranged so as to slide longitudinally with respect to the support strip.

In a preferential configuration, the first blanket and second blanket define a buttonhole configured to allow passage of a strap of the adjustment device.

It is advantageous to provide a belt in which the first blanket and second blanket define at least one buttonhole passing through the support strip, the at least one buttonhole being configured to enable insertion of a wire element forming a gear sling.

Advantageously, the first blanket and second blanket define first and second buttonholes, the wire element forming a loop passing through the first and second buttonholes, the loop being closed by stitching and surrounding at least one of the resistance threads.

In a specific configuration, the first blanket and second blanket define first, second and third buttonholes, the wire element forming a loop and having a first portion passing through the first, second and third buttonholes, and a second portion passing through the first and third buttonholes without passing through the second buttonhole, the loop being closed by stitching and surrounding at least one of the resistance threads.

In another development, the support strip is folded onto itself.

In preferential manner, the belt comprises at least five resistance threads.

Another object of the invention consists in providing a pair of leg loops of a roping harness that is easier to implement while at the same time ensuring good user comfort.

The pair of leg loops of the roping harness comprises:
two support strips,
at least three resistance threads fixed to the longitudinal ends of the two support strips and designed to connect the two support strips, at least two of the resistance threads having at least two different lengths so as to be kept in separated manner from one another in an orthogonal direction to the longitudinal axes of the support strips.

The pair of leg loops is remarkable in that each support strip is knit in such a way as to define:
distinct first and second blankets fixed to one another,
at least a first area where the first blanket is mechanically dissociated from the second blanket and
a plurality of second areas where the first blanket is fixed to the second blanket, the first and second blankets defining guide lines configured to secure the at least three resistance threads with the support strip and to prevent movement of the resistance threads in an orthogonal direction to the longitudinal axis of the support strip, the at least three resistance threads being arranged between the first blanket and the second blanket.

A further object is to provide a roping harness comprising a belt and/or a pair of leg loops according to the different alternative embodiments targeted.

### BRIEF DESCRIPTION OF THE DRAWINGS

Other advantages and features will become more clearly apparent from the following description of particular embodiments of the invention given for non-restrictive example purposes only and represented in the appended drawings, in which:

FIG. 1 represents a schematic view of a roping harness,

FIG. 2a illustrates in schematic manner a belt of a roping harness according to an embodiment of the invention,

FIG. 2b presents a detail of engineering of the guide lines of the resistance threads according to the embodiment illustrated in FIG. 2a,

FIGS. 2c and 2d represent embodiments of the guide lines in cross-sectional view,

FIG. 3 schematically illustrates an embodiment of a belt of a roping harness with a gear sling,

FIGS. 4a and 4b represent cross-sectional views of two fixing modes of a wire element in buttonholes to form a gear sling,

FIG. 5 schematically illustrates an embodiment of the pair of leg loops.

### DETAILED DESCRIPTION

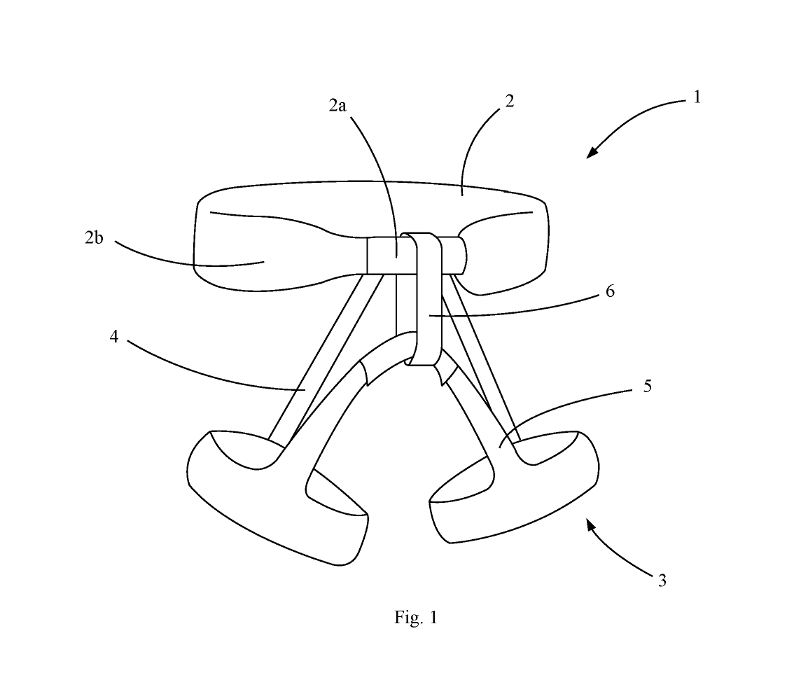

A roping harness 1 such as the one schematically represented in FIG. 1 comprises a belt 2 provided with a waist strap 2b associated with an adjustment device 2a. The harness 1 also has a pair of leg loops 3, each leg loop 3 being connected to the dorsal part of the belt 2 advantageously by two flexible straps 4, and to the ventral part by a hasp 5 via a central ring 6.

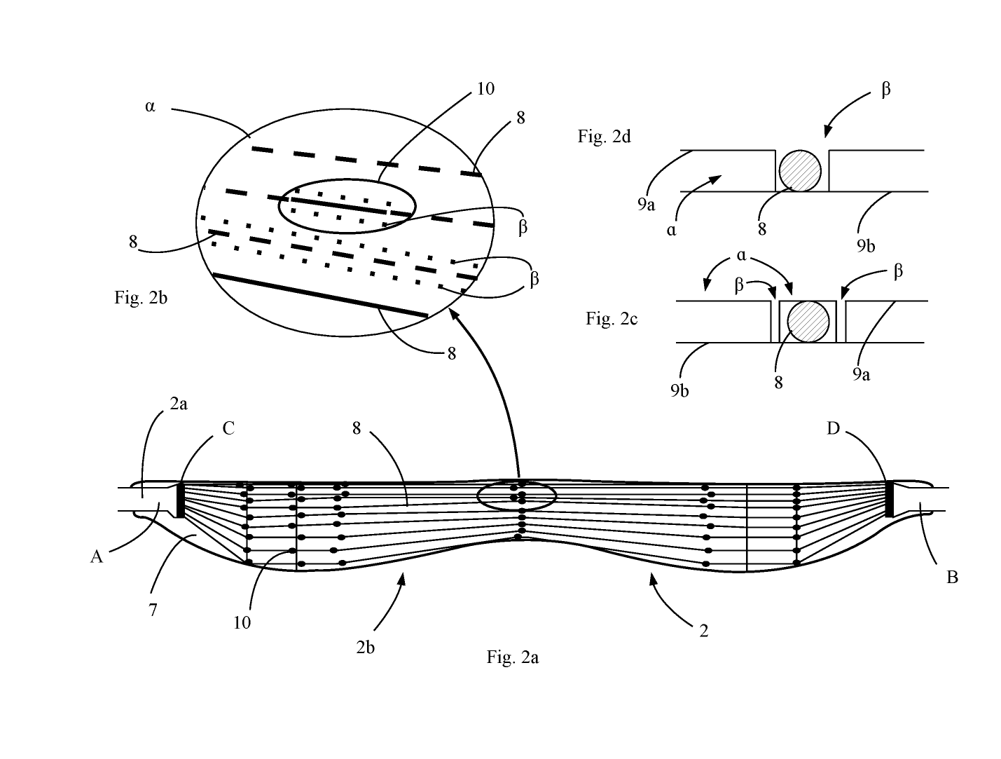

As represented in the FIG. 2a, the adjustment device 2a is secured in first and second positions A and B on a support strip 7 of the waist strap 2b. The adjustment device 2a is configured so as to adjust the circumference of the waist strap to enable the size of the belt 2 to be adjusted to the corpulence of the user. For example, the adjustment device 2a can comprise a strap providing the necessary mechanical strength in case of a fall.

The support strip 7 is configured to provide user comfort by supporting at least his dorsal part. However, the support strip 7 does not have a sufficiently high tensile strength. It is unable to support the user's weight on its own in the event of a fall. The tensile strength is provided by resistance threads 8.

The support strip 7 is made from a knit fabric and more particularly by means of a three-dimensional knit fabric. A knit fabric is a textile object which, unlike other fabrics, can be achieved by means of a single thread. This thread is curved so as to form stitches which are criss-crossed with one another to give a textile surface. Depending on the embodiments, the support strip 7 can be made from a single thread to form a monochrome strap, but it is also possible to make the support strip from several different threads and in particular from threads having different colours and/or different mechanical performances.

A three-dimensional knit fabric is a textile object which comprises several blankets arranged on one another, for example at least two blankets 9a and 9b. A blanket 9a/9b corresponds to a plane formed by a plurality of loops. Each blanket can be made by means of a single thread, but it is also possible to make each blanket with several threads. The thread or threads are curved so as to form stitches which criss-cross with one another to give a textile surface. The different blankets 9a/9b of the three-dimensional textile are secured by criss-crossing at least a part of the loops.

In advantageous manner, the support strip 7 is made by means of at least two blankets 9a and 9b which can be called inner blanket and outer blanket. The inner blanket is designed to come into contact with the user of the harness or to be close to the user. The outer blanket is separated from the user by the inner blanket.

The inner blanket is fixed to the outer blanket and is distinct from the outer blanket which defines an enclosure between the two blankets. In other words, the enclosure is situated between the first blanket and the second blanket.

The mechanical resistance of the belt 2 is not only conferred by the adjustment device 2a, but also by resistance threads 8 fixed to the adjustment device 2a in third and fourth positions C and D. According to a particular embodiment, the first and third positions A and C on the one hand, and the second and fourth positions B and D on the other hand are respectively one and the same.

In order to improve the compactness and flexibility of the harness, it is in fact judicious to use resistance threads 8 rather than straps which are more bulky. The resistance threads 8 advantageously have a circular cross-section, but it is also possible to provide for the straps to have a rectangular cross-section or a cross-section of any other shape. In advantageous manner, the resistance thread presents a diameter less than or equal to 3 mm. If the resistance thread is a strap, in preferential manner, the width is less than or equal to 4 mm.

The resistance threads 8 are advantageously sewn in juxtaposed manner onto the adjustment device 2a. In this way, the seam has a small width in comparison with a seam where the wires are stacked on one another. The surface occupied by the seam on the adjustment device 2a is also smaller when the resistance threads 8 are used instead of straps which are wider.

The resistance threads 8 provide the strength in the dorsal part of the waist strap 2b. The resistance threads 8 can for example be made from polyethylene having at least 100,000 monomers per molecule, and having a molar mass approximately equal to 3*10⁶ g/mol. This type of material is known to have a very high tenacity and abrasion resistance to enable user safety to be ensured in case of a fall, i.e. when the resistance threads 8 are suddenly placed in traction.

The resistance threads 8 are located at least partially inside the enclosure between the first blanket 9a and second blanket 9b and possibly completely inside the enclosure. In this way, one of the blankets partially or completely separates the user from the resistance threads which improves the comfort of the belt. On account of the blanket, the pressure of the threads 8 is better distributed over the surface of the support strip 7, which limits the feeling of discomfort in case of a fall.

In a particular embodiment, the resistance threads 8 can exit from the enclosure in several different places.

As illustrated in FIG. 2a, the belt 2 advantageously comprises at least three resistance threads 8. However, when the number of resistance threads is higher, the forces exerted on the user in case of dynamic use are weaker. It may therefore be wise to manufacture a belt 2 which comprises four or five resistance threads 8, or even seven threads or more. Manufacturing a roping harness 1 with at least five threads rather than three threads increases the volume of the harness 1 very little, and enables the forces exerted on the resistance threads 8 in case of a fall to be better distributed. The resistance to forces of greater intensity is also improved. This can for example be useful for belaying corpulent climbers.

This construction with resistance threads 8 distributed in the belt enables a thinner harness to be produced than most harnesses of the prior art. This configuration also enables the weight and volume of the harness to be reduced. The resistance threads are protected by the first and second blankets. The use of several threads 8 also enable the reliability of the harness to be guaranteed in case of a manufacturing defect of one of the threads, or in case of one of the threads being weakened in the event of a shock.

At least one of the resistance threads 8 is longer than the shortest distance separating the third and fourth positions, i.e. the points where the resistance threads 8 are sewn onto the adjustment device 2a. The axis passing through the third and fourth positions is considered hereafter as being the longitudinal axis of the belt 2.

Preferentially, several resistance threads 8 are longer than the distance between the third and fourth positions. In this way, the resistance threads 8 can be secured in separated manner from one another to the support strip 7 in an orthogonal direction to the longitudinal axis. The force is distributed over a larger surface of support strip 7, which limits the discomfort in case of a fall or more generally when the belt is placed under tension.

When tensioning takes place, the support strip 7 deforms slightly to hug the shape of the user's pelvis, which places the resistance threads 8 in tension around the user.

As indicated in the foregoing, in order to guarantee a good degree of comfort, the resistance threads 8 are judiciously distributed in the support strip 7 orthogonally to the longitudinal axis of the belt. This distribution has to be maintained in the different phases of use of the harness.

According to an advantageous embodiment, the resistance threads 8 are secured on the support strip 7 in a manner separated from one another in the orthogonal direction even when they are placed under tension.

During the knitting phase of the first and second blankets 9a and 9b, it is particularly advantageous to provide for the first and second blankets 9a and 9b to define at least a first area α where the first and second blankets 9a and 9b are mechanically dissociated. It is therefore possible to separate the first and second blankets 9a and 9b in the first area α. It is also advantageous to provide for the first and second blankets 9a and 9b to define second areas β where the first and second blankets 9a and 9b are fixed to one another. It is then impossible to separate the first blanket 9a from the second blanket 9b in the second areas β. In advantageous manner, in the second area β, the first blanket 9a coincides with the second blanket 9b. As an alternative, the relative positions of the first and second blankets 9a and 9b are reversed.

As represented in FIGS. 2a and 2b, during the knitting phase of the support strip 7, the first and second areas α and β define guide lines 10 for the resistance threads 8 between the two ends fixed to the adjustment device 2a. The guide line 10 prevents movement of the resistance thread 8 in the orthogonal direction.

In a first embodiment illustrated in FIG. 2c, the guide line 10 is defined by a first area α separating two second areas β. This first area α is terminated on each side by a second area β along the orthogonal axis of the support strip 7. The first area α enables the resistance thread 8 to be placed between the two blankets 9a and 9b thereby protecting the resistance thread 8 from external stresses while at the same time distributing the forces in the event of a fall.

The two second areas β enable the position of the resistance thread 8 to be fixed in the orthogonal direction. In advantageous manner, the distance separating the two second areas β of a guide line 10 is comprised between 1.5 times the diameter of the resistance threads and 10 times the diameter of the resistance threads.

In equally advantageous manner, it is advantageous to provide for the guide line 10 to be separated from the adjacent guide 10, in the orthogonal direction, by a first area α which is devoid of resistance threads 8 in order to form a more flexible support strip 7 than in a configuration where two adjacent guide lines 10 are separated by a second area β.

This embodiment enables a guide line 10 connecting the two ends of the adjustment device 2a to be achieved. However, in order to facilitate insertion of the resistance threads 8 and to improve the flexibility of the support strip, it is advantageous to replace a continuous guide line by a group of guide lines 10.

A group of guide lines 10 enables the path of the resistance thread 8 to be defined by defining compulsory passage points between the two ends fixed to the adjustment device 2a. The support strip 7 then comprises a plurality of guide lines 10 separated from one another along the longitudinal axis of the support strip 7 and along the orthogonal axis.

As illustrated in FIG. 2a, a group of guide lines 10 is advantageously associated with a resistance thread 8. The guide lines 10 of a group of guide lines 10 are consecutive along the longitudinal axis of the support strip 7.

In a particular embodiment, the guide lines are aligned along the orthogonal axis. However, in advantageous manner, it is of interest to provide for the guide lines not to all be aligned along a single orthogonal axis. In addition to performing groups of guide lines 10 for one or more resistance threads 8, it is also advantageous not to place as many guide lines 10 as resistance threads 8 in the orthogonal direction in order to enhance the flexibility and comfort.

It is advantageous to provide for two consecutive guide lines along the orthogonal axis not to be aligned but, on the contrary, to be offset along the longitudinal axis. Indeed, if each of the resistance threads 8 is secured to the support strip 7 in an orthogonal direction, the support strip 7 comprises an area having an increased rigidity which may give rise to a feeling of discomfort. It is advantageous to distribute a part of the guide lines 10 on one side of an orthogonal axis and the other part of the guide lines 10 on the other side of the orthogonal axis. In advantageous manner, the guide lines 10 are arranged alternately on each side of the orthogonal axis.

In a particular case, the stitches of the knit fabric in the guide line 10 are identical to the stitches of the knit fabric outside the guide line 10 so that the mechanical features are identical between the guide line 10 and the rest of the support strip 7. The guide lines 10 can nevertheless be suggested by a change of colour of the threads. In an alternative embodiment, the stitches of the knit fabric are different in the guide line 10 in comparison with the stitches use outside the guide line 10. The stitch of the knit fabric can be configured to form a salient area marking the shape of the tunnel forming the guideline 10 which facilitates insertion of the resistance thread 8.

In an alternative embodiment illustrated in FIG. 2d, the guide line 10 is formed by a second area β which separates two consecutive first areas α along the orthogonal axis. The second area also separates two consecutive first areas α along the longitudinal axis or along the longitudinal axis of the associated resistance thread.

The position of the resistance thread 8 is defined by a group of guide lines 10 so that the resistance thread 8 alternates between the second areas β and the first areas α which enables the resistance thread 8 to be secured to the support strip 7 and movement thereof in the orthogonal direction to be prevented. This embodiment is particularly advantageous as it is easy to implement and remains very comfortable.

This embodiment enables guide lines 10 to be defined that are visible from one of the surfaces of the support strip 7. It is therefore possible to quickly check that the resistance threads 8 pass through all the guide lines 10 and also to check the wear of the resistance threads 8 for example after a fall.

These two embodiments are particularly advantageous as they enable the guide lines 10 to be defined as soon as the support strip 7 has been manufactured by knitting which enables the manufacturing steps and the manufacturing risks to be reduced.

These two embodiments enable a constant spacing in time to be kept in the orthogonal direction. These two embodiments further enable resistance threads 8 to be had which can slide longitudinally if they are placed under tension.

FIG. 2b illustrates different embodiments with for example a guide line comprising a second area separating two couples of first areas in the longitudinal direction and in the transverse direction. FIG. 2b also illustrates an embodiment where the resistance thread is completely included in the enclosure and blocked by two continuous second areas.

According to one embodiment, a part of the support strip 7 comprises one or more areas with improved ventilation 11 which enable the breathability of the support strip to be increased. Here, the area with improved ventilation is formed by perforated areas which also enhances the flexibility and compactness of the harness 1. Here again, the perforated areas 11 are made at the same time as the knitting step is performed which facilitates implementation.

In a particular embodiment, the support strip 7 can also comprise areas with improved ventilation 11 by means of a different meshing in order to increase the breathability without however forming a perforated area. For example one of the blankets 9a and 9b can form a grid with a repetition of first areas and second areas 9a and 9b. As the support strip 7 does not play any part in the mechanical support of the harness, perforating the support strip 7 does not modify the performances of the harness.

In advantageous manner, the support strip 7 comprises one or more areas with improved ventilation 11 which are made in the form of a grid. In these areas, holes passing through the first blanket 9a and second blanket 9b are formed. It is preferable to provide for the area with improved ventilation 11 to be made at a distance from the guide lines 10 and preferably outside the areas in which the resistance threads 8 pass.

In the areas with improved ventilation, the support strip 7 does in fact present a different mechanical behaviour. By placing the resistance thread 8 in this area, the support strip 7 distribute the forces less well and the harness may be found to be less comfortable than the embodiment where the resistance threads 8 are placed outside the ventilation areas.

As illustrated in FIG. 12, the support strip 7 can comprise one or more buttonholes 12. A buttonhole 12 is a pass-through hole passing through the first blanket 9a and second blanket 9b. The buttonhole 12 is made directly when knitting of the two blankets is performed.

The dimension of the buttonhole 12 is configured to enable the passage of a wire element which is used as gear sling 13 and advantageously to enable insertion of the adjustment device 2a.

Different embodiments can be envisaged. As indicated in the foregoing, the knitted support strip 7 is not configured to support substantial forces. It is therefore advantageous to secure the gear sling 13 on at least one resistance thread 8 and/or on the adjustment device 2a to give the gear sling 13 an enhanced strength.

It is particularly advantageous to provide a buttonhole 12 which enables the passage of the wire element 13 from the outer blanket to the inner blanket. It is advantageous to insert the gear sling 13 from the outer blanket to the inner blanket and from the bottom upwards when the harness is in use as this enables a gear sling to be provided which is less likely to catch on outside elements, which means that it is therefore less liable to be damaged.

In a first case, the gear sling 13 comprises at least one end which is sewn onto the adjustment device 2a so as to provide the required strength.

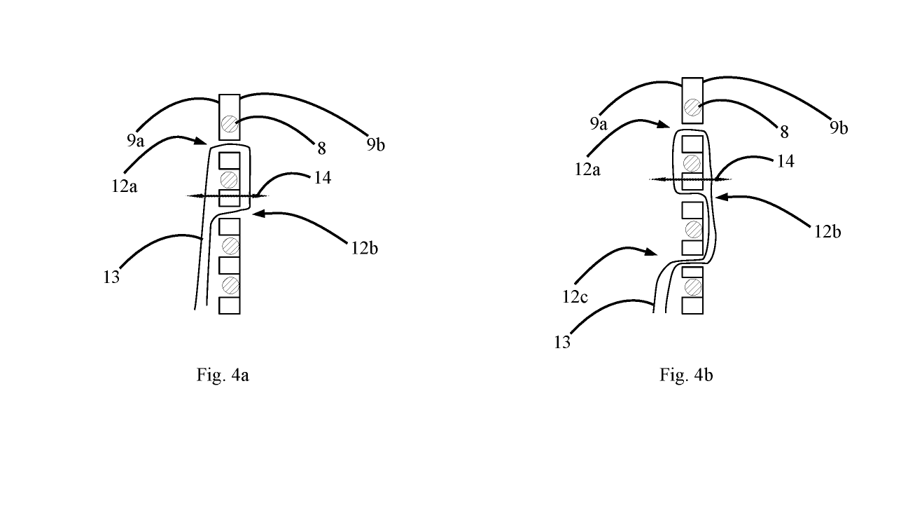

In advantageous manner illustrated in FIG. 4a, the support strip 7 comprises consecutive first and second buttonholes 12a and 12b in a direction orthogonal to the longitudinal axis or substantially orthogonal to the longitudinal axis. Between the two buttonholes 12a and 12b, a part of the wire element 13 is located against the inner surface of the blanket, i.e. it separates the user and the first and second blankets 9a and 9b. Between the two buttonholes 12, another part of the wire element 13 is located against the outer surface. The two parts of the wire element 13 are separated by the two blankets 9a and 9b. A seam 14 is made to secure the two portions of the wire element 13 which are separated by the first and second blankets.

The seam 14 forms a loop in the gear sling 13 which advantageously surrounds a resistance thread 8. Advantageously, the seam 14 is arranged to secure the resistance thread 8 with the gear sling 13. This embodiment is advantageous as it provides a greater freedom of shaping of the gear sling 13 when the latter exits from the buttonhole 12. This also enables finer buttonholes 12 to be formed as a single strand of the wire element passes through each buttonhole 12a/12b.

In another embodiment illustrated in FIG. 4b, the support strip 7 comprises consecutive first, second and third buttonholes 12a, 12b and 12c in a direction perpendicular to the longitudinal axis or substantially perpendicular to the longitudinal axis. Between the two buttonholes 12a and 12b, a part of the wire element 13 is located against the inner surface of the blanket, i.e. it separates the user and the first and second blankets 9a and 9b. Between the two buttonholes 12, another part of the wire element 13 is located against the outer surface. The two parts of the wire element 13 are separated by the two blankets 9a and 9b. A seam 14 is made to secure the two portions of the wire element 13 which are separated by the first and second blankets.

Between the second and third buttonholes 12b and 12c, two portions of the wire element 13 of the gear sling are located against the inner surface of the blanket, i.e. these two portions separate the user and the first and second blankets 9a and 9b. The wire element 13 forming the loop has a first portion passing through the first, second and third buttonholes 12a, 12b, 12c, and a second portion passing through the first and third buttonhole 12a, 12c without passing through the second buttonhole 12b.

This embodiment is advantageous as it provides a greater freedom of shaping of the gear sling 13 when it exits from the buttonhole. This also enables a sheath to be formed between the second and third buttonholes 12b and 12c inside which the gear sling 13 is inserted. This sheath enables the amplitude of movement of the gear sling to be partially limited. The inventors observed that during use, insertion and extraction of equipment in and from the gear sling are easier to perform. It is advantageous to form a portion of the wire element from a stronger material than the other portion of the wire element in order to strengthen the gear sling even more on exit from the sheath.

It is also advantageous to manufacture a buttonhole 12 which enables insertion of the adjustment system 2a. In this way, the seams are arranged on the inner surface of the support strip 7 and the adjustment system 2a exits on the outer surface to facilitate adjustment of the belt of the harness.

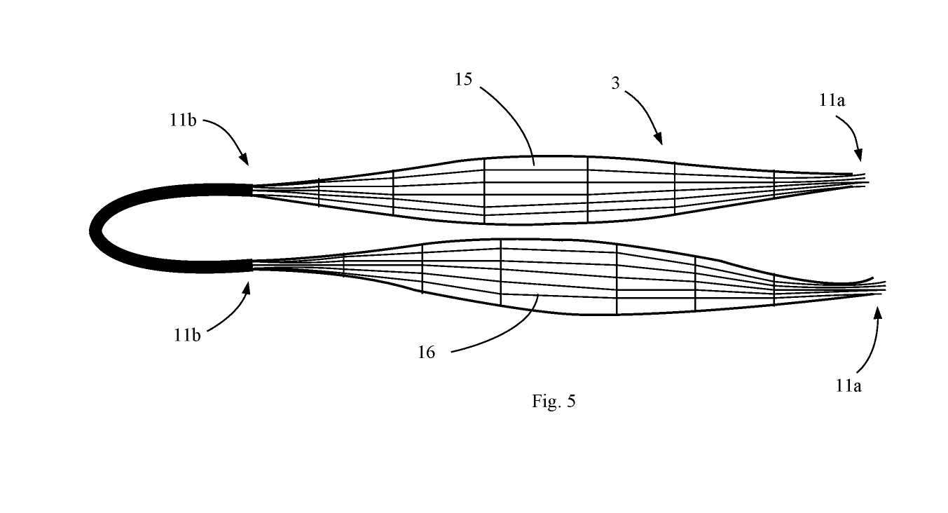

As illustrated in FIG. 5, it is also advantageous to manufacture the support strip of one of the leg loops or of both of the leg loops by means of a knit fabric. Manufacturing of the support strip 15 of the leg loops can be performed in the same manner as the embodiments described to form the support strip 7 of the belt and in particular the embodiments describing securing of the resistance threads 8 and/or ventilation of the support strip.

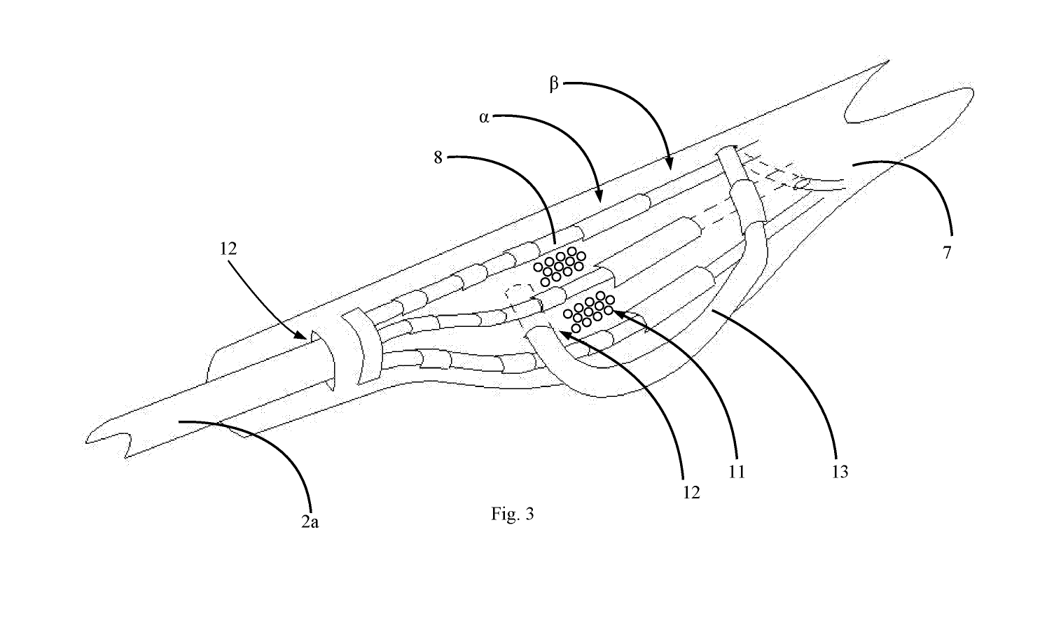

The pair of leg loops 3 can also be manufactured by means of two independent flexible support strips 15 connected to one another by at least three resistance threads 11 (cf. FIG. 3), the resistance threads 16 forming the hasp 5. According to an alternative embodiment, the pair of leg loops 3 can contain four or five resistance threads 16, or even more, for example to enhance the strength of the harness 1 if the user is stoutly built.

In one embodiment, each leg loop 3a and 3b is formed on the one hand by a seam of the ends 16a of the resistance threads 16 on a part 16b of the threads 16 situated at the edge of the hasp 5, at the level of the junction between the hasp 5 and the support strips 15, and on the other hand by the seam of the ends of each support strip 15 on one another. As for the belt 2, the strength of the leg loops 3a and 3b is provided by the resistance threads 16.

Furthermore, in similar manner to the features developed in relation with the belt 2, the resistance threads 16 advantageously have different lengths so as to be kept separated from one another with respect to a direction orthogonal to the longitudinal axis of the support strips 15, the resistance thread 16 having a minimum length corresponding to that positioned on the longitudinal axis of the support strips 15. The resistance threads 16 can be secured to the support strips 15 in the same way as to the belt 2 while being able to slide along the longitudinal axis of the leg loops.

It is advantageous to use guide lines 10 to limit the movement of the resistance threads 16 in a direction orthogonal to the longitudinal axis of the leg loops.

User discomfort is then advantageously limited when the resistance threads 16 are placed under tension, for example when the user sits in the harness 1.

The mechanical properties of the support strips 15 and of the resistance threads 16 of the leg loops are preferably identical to those of the support strip 7 and of the resistance threads 8 of the belt. The materials chosen for manufacturing the belt 2 and the pair of leg loops 3 are preferably also identical.

As an alternative to the embodiment of the leg loops which has just been described, it is quite conceivable to manufacture adjustable leg loops each comprising an adjustment device similar to the one described in relation with the belt 2 of the harness 1.

A light, compact, solid and comfortable roping harness 1 is thus obtained, able to be used both for mountain climbing or for ski-mountaineering where lightness and compactness are of prime importance, and also able to be used for rock climbing where comfort is one of the most important criteria.

To produce such a harness, it is advantageous to knit the support strips 7/15 and to then insert the resistance threads 8/16 in the guide lines 10 of the belt and/or leg loops. The resistance threads 8/16 are fixed to the adjustment device 2a or are connected to form the hasp 5.

In a particular embodiment, the support strips 7 and/or 15 are formed by a knit fabric which has opposite first and second surfaces. This knit fabric is folded so as to place the two parts of the first surface which are separated by the fold in contact with one another.

In this way, the resistance threads are arranged in the knit fabric before the folding step and they are arranged inside the support strip so as to make the resistance threads inaccessible. In the particular embodiment, the knit fabric is produced by a circular knitting method.

The wire element is advantageously inserted in the buttonholes to form the gear sling.

1. Belt of a roping harness comprising:
a support strip designed to support a dorsal part of a user,
an adjustment device of a circumference of the belt having first and second ends fixed to the support strip in first and second positions,
at least three resistance threads each sewn onto the adjustment device in specific third and fourth positions,
at least one of the resistance threads presenting a longer length than a distance separating the third and fourth positions along the support strip,
wherein the support strip is knit in such a way as to define:
distinct first and second blankets fixed to one another,
at least a first area where the first blanket is mechanically dissociated from the second blanket and
a plurality of second areas where the first blanket is fixed to the second blanket, the first and second blankets defining guide lines configured to secure the at least three resistance threads with the support strip and to prevent movement of the at least three resistance threads in an direction orthogonal to a longitudinal axis of the support strip, the at least three resistance threads being arranged between the first blanket and the second blanket.

2. Belt of a roping harness according to claim 1, wherein at least one of the resistance threads is associated with a group of guide lines, each guide line of the group of guide lines being formed by a second area where the first blanket is inseparable from the second blanket, two guide lines of the groups of guide lines being separated by a first area along the longitudinal axis.

3. Belt of a roping harness according to claim 1, wherein the at least three resistance threads are arranged so as to slide longitudinally with respect to the support strip.

4. Belt of a roping harness according to claim 1, wherein the adjustment device comprise a strap and wherein the first blanket and second blanket define a buttonhole configured to allow passage of the strap of the adjustment device.

5. Belt of a roping harness according to claim 1, wherein the first blanket and second blanket define at least one buttonhole passing through the support strip, the at least one buttonhole being configured to allow insertion of a wire element forming a gear sling.

6. Belt of a roping harness according to claim 5, wherein the first blanket and second blanket define first and second buttonholes, the wire element forming a loop passing through the first and second buttonholes, the loop being closed by a seam and surrounding at least one of the resistance threads.

7. Belt of a roping harness according to claim 5, wherein the first blanket and second blanket define first, second and third buttonholes, the wire element forming a loop and having a first portion passing through the first, second and third buttonholes, and a second portion passing through the first and third buttonhole without passing through the second buttonhole, the loop being closed by a seam and surrounding at least one of the resistance threads.

8. Belt of a roping harness according to claim 1, wherein the support strip is folded onto itself.

9. Belt of a roping harness according to claim 1, comprising at least two additional resistance threads.

10. Pair of leg loops of a roping harness comprising:
two support strips,
at least three resistance threads fixed to longitudinal ends of the two support strips and designed to connect the two support strips, at least two of the resistance threads having at least two different lengths so as to be kept in separated manner from one another in an direction orthogonal to longitudinal axes of the support strips
wherein each support strip is knit in such a way as to define:
distinct first and second blankets fixed to one another,
at least a first area where the first blanket is mechanically dissociated from the second blanket and
a plurality of second areas where the first blanket is fixed to the second blanket, the first and second blankets defining guide lines configured to secure the at least three resistance threads with the support strip and to prevent movement of the at least three resistance threads in an direction orthogonal to the longitudinal axis of the support strip, the at least three resistance threads being arranged between the first blanket and second blanket.

11. Roping harness comprising a belt according to claim 1.

12. Roping harness comprising a pair of leg loops according to claim 10.
